(19) United States
(12) Patent Application Publication
(10) Pub. No.: US 2025/0290756 A1
(43) Pub. Date: Sep. 18, 2025

(54) METHOD FOR MONITORING WHETHER A VEHICLE HAS CROSSED A BOUNDARY OF A DRIVABLE AREA, AND DRIVER ASSISTANCE SYSTEM

(71) Applicant: Continental Autonomous Mobility Germany GmbH, Ingolstadt (DE)

(72) Inventors: Qiangqiang Zhu, Langen (DE); Moritz Schrader, Frankfurt am Main (DE); Stefan Hahn, Hösbach (DE)

(73) Assignee: Continental Autonomous Mobility Germany GmbH, Ingolstadt (DE)

(21) Appl. No.: 18/858,590

(22) PCT Filed: Mar. 27, 2023
(86) PCT No.: PCT/DE2023/200065

§ 371 Date: Oct. 21, 2024

(30) Foreign Application Priority Data
Apr. 19, 2022 (DE) 10 2022 203 826.6

(51) Int. Cl. G01C 21/28; B60W 30/09; B60W 30/12

(52) U.S. Cl. CPC G01C 21/28; B60W 30/09; B60W 30/12; B60W 2554/80; B60W 2720/24

(57) ABSTRACT

The present disclosure relates to a computer-implemented method for checking whether a vehicle moving along a trajectory has crossed a boundary of a driveable area, by determining a direction of rotation.

### CROSS-REFERENCE TO RELATED APPLICATIONS

The present application is a National Stage Application under 35 U.S.C. § 371 of International Patent Application No. PCT/DE2023/200065 filed on Mar. 27, 2023, and claims priority from German Patent Application No. 10 2022 203 826.6 filed on Apr. 19, 2022, in the German Patent and Trademark Office, the disclosures of which are herein incorporated by reference in their entireties.

### TECHNICAL FIELD

The invention relates to the field of driver assistance systems of vehicles. The invention relates in particular to a robust method for checking whether a vehicle guided by a driver assistance system crosses the boundaries of the permissible free space when driving along a trajectory.

### BACKGROUND

Driver assistance systems in vehicles are generally known. Distance-based methods are also known that involve checking whether the vehicle, which is to be moved on a trajectory, maintains the predefined distance from the boundaries of the driveable area along the entire movement path described by the trajectory. This is done taking into account the vehicle geometry, that is to say in particular the surface area created by projecting the vehicle body contour onto the road.

Methods are also known that involve checking whether a point of intersection arises between the driving corridor of the vehicle, that is to say the area covered by the projection of the vehicle body contour onto the road when the vehicle is moving along the trajectory, and the boundary lines of the driveable area, that is to say whether the driving corridor intersects a boundary of the driveable area. In known methods, the point of intersection with the boundary of the driveable area has to be computed.

The problem with the known methods is that they are very computationally intensive, since in each case systems of equations have to be solved in order to determine the distance of the vehicle from the boundary lines of the driveable area or the point of intersection of a section of the vehicle body contour with a boundary line. Moreover, it is not always possible to guarantee that the solution to the system of equations leads to real solutions. If no real solutions are found, a further check has to be carried out.

### SUMMARY

Proceeding from this, an object of the present disclosure is to specify a method that makes it possible, with low computational effort, to reliably check whether a boundary of a driveable area has been crossed.

The object is addressed by a method having the features of independent patent claim 1. The dependent claims relate to example embodiments. Coordinate patent claim 11 relates to a driver assistance system that is designed to check whether a boundary of a driveable area has been crossed.

According to a first aspect, what is disclosed is a method for checking whether a vehicle has crossed a boundary of a driveable area. The vehicle has a driver assistance system that is designed to move the vehicle along a trajectory in automated or partially automated fashion. The driver assistance system is additionally configured to perform the checking method, including the following steps:

Information about at least one boundary line of the driveable area is first received. The information may be provided by a surroundings detection unit of the vehicle, which creates an environment model of the surroundings around the vehicle. By way of example, the boundary line may identify a boundary in free space, which in particular defines a lane on which the vehicle is to be moved. As an alternative, the boundary line may characterize a surrounding object in the environment of the vehicle.

In addition, information about a driving corridor of the vehicle is received. The driving corridor is the area that is covered by a projection of the vehicle body contour onto the road when driving through the trajectory. In other words, the driving corridor is a tube-like area at least with a width equal to the vehicle width (also wider in the case of incorporating a safety buffer).

The boundary line is defined by a multiplicity of points, that is to say by a polyline including multiple straight lines, wherein the straight lines each extend between two adjacent points. As an alternative, the boundary line may also be formed by a continuous line.

A first and a second point on the boundary line of the driveable area are selected. The first point in this case lies behind the second point in the direction of travel of the vehicle. The points thus define a section of the boundary line with respect to which the check as to whether or not the boundary line is crossed when driving through the trajectory is carried out.

A third point, lying on the edge of the driving corridor of the vehicle, is also identified. The driving corridor of the vehicle may be defined either by continuous lines or else by a multiplicity of vehicle body contours positioned at different positions along the trajectory. The vehicle body contour may be formed for example by a polygon, in particular by a rectangle, which describes the vehicle body contour at least approximately when looking down onto the vehicle from above. The vehicle body contour may be selected to be larger than the actual vehicle body contour in order to obtain a safety buffer.

The position of the third point relative to the line between the first and second points is then ascertained by checking whether a clockwise or counterclockwise first direction of rotation is present when traversing a polygon polyline formed from the first point to the third point going via the second point. In other words, the three points, two of which lie on the boundary line and one of which indicates a point of the driving corridor of the vehicle, are connected by a polyline. This polyline may be open, that is to say it may end at the third point, or it may be closed, so as to result in a triangle. The direction of rotation that arises when the polyline is traversed such that the path between the two points on the boundary line of the driveable area is traversed in the direction of travel is then checked. As an alternative or in addition, it may be checked whether the first to third points are collinear, that is to say lie on a straight line.

In addition, at least one fourth point lying on the edge of the driving corridor of the vehicle and different from the third point is identified.

The position of this fourth point relative to the line between the first and second points is then ascertained by checking whether a clockwise or counterclockwise second direction of rotation is present when traversing a polyline formed from the first point to the fourth point going via the second point. In other words, the three points, two of which lie on the boundary line and one of which indicates a further point of the driving corridor of the vehicle, are connected by a polyline. This polyline may be open, that is to say it may end at the fourth point, or it may be closed, so as to result in a triangle. The direction of rotation that arises when the polyline is traversed such that the path between the two points on the boundary line of the driveable area is traversed in the direction of travel is then checked. As an alternative or in addition, it may be checked whether the first, second and fourth points are collinear, that is to say lie on a straight line.

Finally, it is checked whether the boundary of the driveable area has been crossed. This is done by comparing the first and second directions of rotation. If they are identical, this is an indication that the boundary of the driveable area has not been crossed. Different directions of rotation, on the other hand, are an indication that the boundary of the driveable area has been crossed. As an alternative or in addition, the results of the collinearity check may be used to identify whether the boundary of the driveable area has been crossed.

The method has the technical advantage of enabling a technically simple check with little computational effort by virtue of the checking method based on the direction of rotation, since the checking method is point-based, meaning that it is possible to use computationally efficient vector calculation methods, and it is thus not necessary to solve a computationally intensive system of equations. In addition, the checking method makes it possible to identify whether the driveable area has already been completely left, which improves the safety of the checking method.

According to one example embodiment, the third and fourth points are each a vertex of a polygon that replicates the vehicle body contour. The third and fourth points relate to a common sideline of the vehicle body contour. The third and fourth points are each a vertex of the right or left sideline of the vehicle body contour. This makes it easy to check whether the sideline of the vehicle body contour intersects the boundary line of the driveable area. It is possible to draw further relevant conclusions from any other additional information that may be available, for example whether a left corner or a right corner of the vehicle body contour is involved, or whether the first and second points lie on a boundary line to the left or right of the vehicle, for example whether the vehicle lies completely outside the driveable area.

According to one example embodiment, when checking whether the boundary of the driveable area has been crossed, it is ascertained whether the first and second directions of rotation are the same or different. If the first and second directions of rotation are the same, it may be concluded from this that the third and fourth points lie on the same side of the boundary line. In the case of different directions of rotation, it may be concluded that the third and fourth points lie on different sides of the boundary line, and thus that the vehicle will enter an area not intended for driving when driving through the trajectory, or that there is a risk of collision with a surrounding object.

According to one example embodiment, the at least one boundary line of the driveable area is approximated by multiple points spaced apart from one another. The pairs of points of the boundary line are selected at successive times as first and second points and are used to ascertain the first and second directions of rotation and to check whether the boundary of the driveable area has been crossed. This makes it possible to iteratively check whether the driveable area has been crossed based solely on pairs of points of the boundary line, without a system of equations.

According to one example embodiment, the driveable area has a left and a right boundary line that are spaced apart from one another and define a lane. The vehicle body contour is approximated by a rectangle having a pair of left corners and a pair of right corners. A first and second direction of rotation are ascertained for the pair of left corners, that is to say the first direction of rotation for one of the left corners and the second direction of rotation for the other left corner. Based on the first and second directions of rotation, it is checked whether the vehicle has crossed the left boundary line of the driveable area. The method is thus able to be applied advantageously and with reduced computational effort to achieving compliance with the left boundary line of a predefined lane.

According to one example embodiment, the driveable area has a left and a right boundary line that are spaced apart from one another and define a lane. The vehicle body contour is approximated by a rectangle having a pair of left corners and a pair of right corners. A first and second direction of rotation are ascertained for the pair of right corners, that is to say the first direction of rotation for one of the right corners and the second direction of rotation for the other right corner. Based on the first and second directions of rotation, it is checked whether the vehicle has crossed the right boundary line of the driveable area. The method is thus able to be applied advantageously and with reduced computational effort to achieving compliance with the right boundary line of a predefined lane.

According to one example embodiment, the driveable area has a left and a right boundary line that are spaced apart from one another and define a lane. The vehicle body contour is approximated by a rectangle having two left corners and two right corners. The position of at least the two left corners relative to the line between the first and second points lying on the left boundary line is checked. In this case, a direction of rotation is determined for each of the two left corners by determining a direction of rotation for each corner when traversing a polyline formed from the first point to the respective corner of the vehicle body contour going via the second point, so as to ascertain at least two directions of rotation. It is then checked whether the directions of rotation are oriented clockwise. It is thereby possible to ascertain whether the vehicle is located to the right of the left boundary line. If necessary, the direction of rotation may be determined and checked for more than two corners, in particular for all four corners of the rectangle replicating the vehicle body contour.

According to one example embodiment, the driveable area has a left and a right boundary line that are spaced apart from one another and define a lane. The vehicle body contour is approximated by a rectangle having two left corners and two right corners. The position of at least the two right corners relative to the line between the first and second points lying on the right boundary line is checked. In this case, a direction of rotation is determined for each of the two right corners by determining a direction of rotation for each corner when traversing a polyline formed back from the first point to the respective corner going via the second point, so as to ascertain at least two directions of rotation. It is then checked whether the directions of rotation are oriented counterclockwise. It is thereby possible to ascertain whether the vehicle is located to the left of the right boundary line.

According to one example embodiment, the boundary line of the driveable area relates to a boundary line of a localized surrounding object in the surrounding area of the vehicle. The surrounding object is described by a bounding box. The first and second points define a line of the bounding box that relates to a side of the surrounding object that faces the vehicle. It is thereby possible to check whether a collision occurs between the vehicle and the surrounding object when driving through the trajectory.

According to one example embodiment, the vehicle body contour is approximated by a rectangle having four corners. The surrounding object is approximated by a rectangular bounding box having four corners. For each line of the rectangular bounding box, in each case the position of all of the corners of the rectangle of the vehicle body contour relative to the respective line is determined by in each case determining the direction of rotation when traversing the polyline between the end points of the respective line of the rectangular bounding box and the respective corner of the rectangle of the vehicle body contour. A large amount of direction of rotation information is thereby obtained. After the directions of rotation have been determined, it is checked whether all of the directions of rotation are the same.

It is thereby possible to check whether there is a collision with the surrounding object in the longitudinal or lateral direction.

According to a further aspect, the present disclosure relates to a driver assistance system that is designed to check whether a vehicle has crossed a boundary of a driveable area. The driver assistance system includes multiple sensors arranged in a manner distributed around a vehicle and a computing unit for processing the information provided by the sensors. The computing unit is configured to perform the following steps:
Receiving information about at least one boundary line of the driveable area;
Receiving information about a driving corridor of the vehicle, wherein the driving corridor is the area covered by a projection of the vehicle body contour onto the road when driving through the trajectory;
Selecting a first and a second point on the boundary line of the driveable area, wherein the first point lies behind the second point in the direction of travel of the vehicle;
Identifying a third point lying on the edge of the driving corridor of the vehicle;
Ascertaining the position of the third point relative to the line between the first and second points by checking whether a clockwise or counterclockwise first direction of rotation or collinearity between the first, second and third points is present when traversing a polygon polyline formed from the first point to the third point going via the second point;
Identifying at least one fourth point lying on the edge of the driving corridor of the vehicle and different from the third point;
Ascertaining the position of the fourth point relative to the line between the first and points by checking whether a clockwise or counterclockwise second direction of rotation or collinearity between the first, second and fourth points is present when traversing a polygon polyline formed from the first point to the fourth point going via the second point; and
Checking whether the boundary of the driveable area has been crossed by comparing the first and second directions of rotation and/or the results of the collinearity check.

For the purposes of the present disclosure, the terms “approximately”, “substantially” or “about” mean deviations from the respective exact value by +/−10%, such as by +/−5%, and/or deviations in the form of changes insignificant for the function.

Developments, advantages and possible applications of the present disclosure also result from the following description of example embodiments and from the figures. In this case, all of the features described and/or illustrated in the figures are fundamentally the subject matter of the present disclosure, either in themselves or in any desired combination, irrespective of their combination in the claims or their back-reference. The content of the claims is also made part of the description.

### BRIEF DESCRIPTION OF THE DRAWINGS

The present disclosure will be explained in more detail below with reference to the figures using example embodiments. In the figures:

FIG. 1 shows, by way of example, a schematic plan view of a vehicle having a driver assistance system including multiple sensors and a computing unit;

FIG. 2 shows, by way of example, different arrangements of points A, B, C, which, with a given direction of revolution of the points, illustrates the resulting direction of rotation;

FIG. 3 shows, by way of example, the movement of a vehicle along a trajectory using a pair of boundary lines defining a lane and the example application of the direction of rotation method for checking whether the boundary lines of the lane have been crossed;

FIG. 4 shows, by way of example, the movement of a vehicle based on a trajectory along a lane, wherein the left boundary line of the lane is crossed;

FIG. 5 shows, by way of example, the movement of a vehicle based on a trajectory through a driving tube delimited laterally by multiple surrounding objects, wherein a collision with a surrounding object occurs when driving along the trajectory; and

FIG. 6 shows a flowchart illustrating the steps of the method for checking whether a boundary of a driveable area has been crossed.

### DETAILED DESCRIPTION

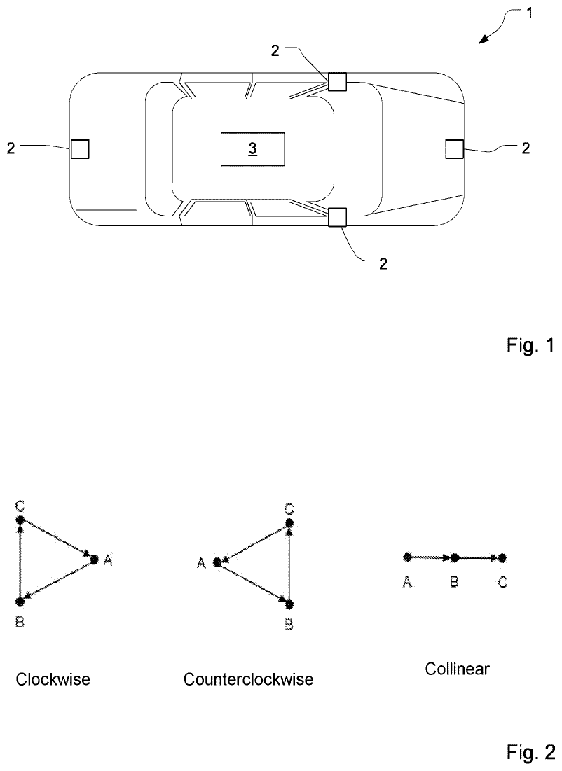

FIG. 1 shows, by way of example and schematically, a vehicle 1 having a driver assistance system for carrying out automatic or partially automatic driving maneuvers. The driver assistance system may be designed in particular to recognize areas able to be driven automatically or partially automatically by the vehicle 1 and to control the vehicle 1 such that the vehicle does not cross any boundaries of the driveable area. By way of example, the driveable area may be a lane having a left and a right boundary line. As an alternative, the driveable area may be restricted by one or more surrounding objects with which a collision is to be avoided.

The vehicle 1 has multiple sensors 2, by way of which the surrounding area of the vehicle 1 is able to be detected. The sensors 2 are coupled to a computing unit 3 of the driver assistance system, which processes the sensor information and provides information about at least one boundary line of the driveable area. This surroundings detection gives the driver assistance system the ability to identify local areas over which the vehicle 1 is able to be guided without collision.

The driver assistance system is additionally designed to determine a trajectory on which the vehicle 1 is moved during the driving maneuver carried out in autonomous or partially autonomous fashion. When driving through the trajectory, the vehicle is moved along a driving corridor. The driving corridor is given by the area that is covered or temporarily occupied by the vehicle body when the vehicle is moving. The vehicle has a peripheral vehicle body contour that results for example when looking down on the vehicle 1 from above, that is to say from a bird's eye view. The projection of this vehicle body contour vertically downwards onto the road defines the area of the road occupied by the vehicle 1. This area necessarily has to be free to be driven through in order to be able to move the vehicle 1 without collision. The driving corridor is thus tube-like and has a width at least equal to the width of the vehicle body contour. The driving corridor may also be designed to be wider than the vehicle width in order to increase the safety of the method.

In order to be able to identify whether the vehicle 1 crosses a boundary of the driveable area, it is possible to apply a direction of rotation-based checking method.

FIG. 2 shows three possibilities as to how a triple of points A, B and C may be arranged. By way of example, the line between points B and C forms a section of a boundary line of the driveable area. By way of example, point A may be a vertex of the vehicle body contour of the vehicle 1. Points A, B and C span a triangle, generally a polygon. When traversing the polyline along the points in a predefined sequence, for example from point B to point A going via point C, it is possible to ascertain position information regarding point A relative to the line between points B and C. If a clockwise direction of rotation results when traversing the polyline, it may be concluded that point A lies to the right of the line BC. In the opposite case, it may be concluded that point A lies to the left of the line BC if a counterclockwise direction of rotation results when traversing the polyline (middle illustration in FIG. 2). The third case is the collinear case in which all three points A, B, C lie on a straight line, as shown in the right illustration in FIG. 2.

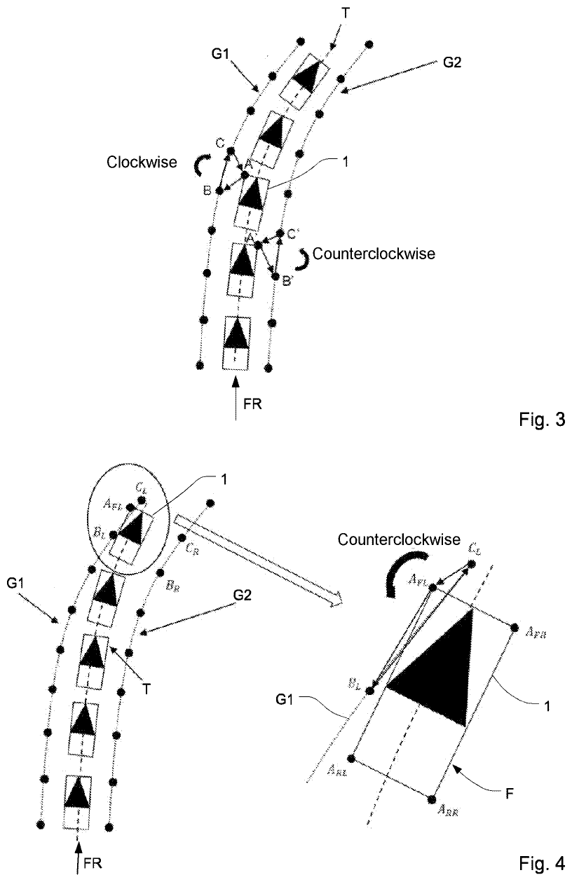

FIG. 3 shows one example application of the described method, in which the vehicle 1 is moved on a trajectory T in the direction of travel FR on a lane defined by a left boundary line G1 and a right boundary line G2. The boundary lines G1, G2 may be replicated by discrete points that are spaced apart from one another. In the example embodiment according to FIG. 3, points B and C are two points of the left boundary line G1 and points B′ and C′ are two points of the right boundary line G2.

The vehicle body contour of the vehicle 1 is replicated by a rectangle. The size of the rectangle is selected such that all areas of the vehicle 1 lie within this vehicle body contour, for example including the side mirrors of the vehicle 1.

In order to ensure that the vehicle 1 is able to be moved on the trajectory T without collision, it is necessary to check that the driving corridor of the vehicle 1, resulting from the movement of the vehicle body contour along the trajectory T, does not have any point of intersection with the boundary lines G1, G2. The driving corridor of the vehicle 1 may in particular be a tube-like area that must lie within the boundary lines G1, G2 in order to guarantee that the trajectory T is free from collisions.

The check as to whether the trajectory T is free from collisions may be carried out iteratively based on discrete vehicle positions of the vehicle 1, as indicated in FIG. 3 by the multiplicity of rectangles representing the vehicle 1.

At a defined vehicle position, it must be checked whether the left vehicle contour line is located to the right of the left boundary line G1 and whether the right vehicle contour line is located to the left of the right boundary line G2. This check may be carried out, in the example embodiment shown, based on front left and rear left corners, or the front right and rear right corners. It is necessary to check in more detail whether the front left and rear left corners have the same position in relation to the left boundary line G1, that is to say both lie to the right of the left boundary line G1. The same applies to the front right and rear right corners in relation to the right boundary line G2. These two corners must also have the same position relative to the right boundary line G2, that is to say both must lie to the left of the right boundary line G2.

By way of example, this check involves determining a pair of points of the left boundary line G1 of the lane, this pair of points being close to the left vehicle contour line. In the example embodiment shown, these are points B and C. The front left corner of the vehicle 1 is denoted point A. For the polyline consisting of the sequence of points B-C-A, this results in a clockwise direction of rotation.

The same check is then performed for the rear left corner of the vehicle 1 relative to points B and C. If the polygon polyline is traversed from point B to C back to B going via the rear left corner, this also results in a clockwise direction of rotation. The result of the check is thus that both vertices of the left vehicle contour line lie on the same side of the left boundary line G1, that is to say the left vehicle contour line does not intersect the left boundary line G1, that is to say there is no collision with the left boundary line G1. It may additionally be identified that both vertices of the left vehicle contour line lie to the right of the left boundary line G1.

A similar check is carried out with regard to the two vertices of the right vehicle contour line relative to the right boundary line G2.

As shown in FIG. 3, the right boundary line G2 is also represented by a multiplicity of points, wherein points B′ and C′ define a line that forms a portion of the right boundary line G2. In order to be able to identify whether the vehicle 1 does not cross this right boundary line G2 when driving through the driving corridor, the algorithm described above is implemented analogously for the vertices of the right vehicle contour line. The direction of rotation that results when the polygon polyline is traversed in the direction of travel described above is thus determined for the front right corner of the vehicle contour line A′ and the resulting polyline B′-C′-A′. This is counterclockwise in the example embodiment shown.

A similar check is then performed for the rear right corner of the vehicle 1 relative to points B′ and C′. If the polygon polyline is traversed from point B′ to C′ back to B′ going via the rear right corner of the vehicle 1, this also results in a counterclockwise direction of rotation. The result of the check is thus that both vertices of the right vehicle contour line lie on the same side of the right boundary line G2, that is to say the right vehicle contour line does not intersect the right boundary line G2 and there is thus no collision with the right boundary line G2. It may additionally be identified that both vertices of the right vehicle contour line lie to the left of the right boundary line G2.

The checking steps described above may be performed iteratively for multiple vehicle positions along the driving corridor and for different sections (defined by pairs of points B-C or B′-C′) of the boundary lines G1 and G2 in order to guarantee that the trajectory T is free from collisions.

FIG. 4 shows an example in which the trajectory T is determined such that the driving corridor of the vehicle 1 intersects the left boundary line G1 in the area marked with the oval, and a boundary of the driveable area is thus crossed.

The section of the boundary line G1 in the area of the vehicle 1 is defined by points B_{L} and C_{L}. The front left corner of the vehicle 1 is denoted point A_{FL}. For the polyline consisting of the sequence of points B_{L}-C_{L}-A_{FL}, this results in a counterclockwise direction of rotation. When applying the proposed method to the rear left corner of the vehicle 1, denoted point A_{FL}, with respect to the boundary line G1, which in turn is defined by points B_{L} und C_{L}, this results in a clockwise direction of rotation when traversing the polyline along points B_{L}- C_{L}- A_{FL}, Since the directions of rotation for the front and rear corners are different, the proposed method makes it possible to recognize crossing of the boundary line G1.

In order to recognize that the vehicle 1 does not lie completely outside the driveable area, it may be useful to check, in each cycle or at longer time intervals, the position of the left or right pairs of corners of the vehicle contour line relative to at least one boundary line G1, G2. In the event for example that a counterclockwise direction of rotation results for the left corners of the vehicle contour line of the vehicle 1 relative to the line identified by points B_{L} and C_{L} and this direction of rotation indicates that the left corners of the vehicle body contour lie to the left of the left boundary line G1, it may be concluded from this that the vehicle 1 is already located outside the driveable area at this point of the trajectory T and the boundary of the driveable area has thus been crossed.

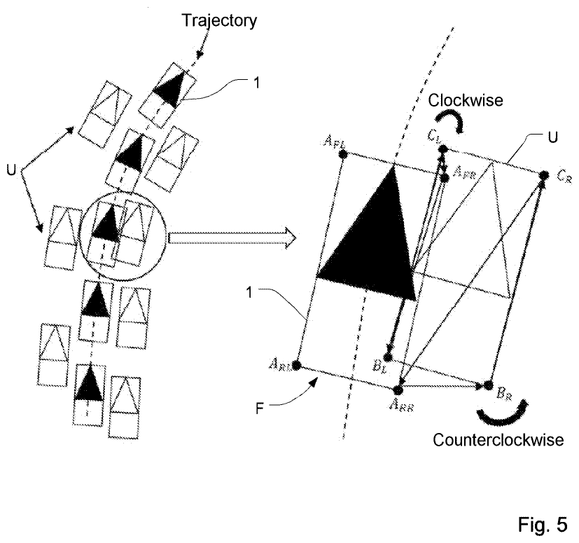

FIG. 5 shows an example embodiment in which the boundary of the driveable area is not defined by a boundary line in free space, but rather the driveable area is delimited laterally by surrounding objects U having a limited local extent. The method may thus be used directly to prevent a collision with the surrounding objects U.

The surrounding object U may be approximated by a surrounding object contour, which is formed for example as a polygon with multiple vertices, in particular as a rectangle. In order to ensure that there is no collision between the vehicle 1 and the surrounding object U, there must be no collision in the lateral direction (that is to say with respect to the left or right boundary line of the surrounding object contour) and in the longitudinal direction (that is to say with respect to the front or rear boundary line of the surrounding object contour).

In FIG. 5, the corners of the vehicle body contour of the vehicle 1 are denoted by points A_{FL}, A_{RL}, A_{FR}, A_{RR}. The corners of the surrounding object contour are denoted B_{L}, C_{L}, B_{R}, C_{R}. In order to identify whether the vehicle 1 will not collide with the surrounding object U, the following steps may be performed:

It is first checked whether a lateral collision situation is present. For this purpose, for each corner of the vehicle body contour of the vehicle 1, its position relative to the side contour lines B_{L}-C_{L} and B_{R}-C_{R} of the surrounding object U is determined based on the direction of rotation method described above. This means that, for the point triplets B_{L}-C_{L}-A_{FL}, B_{L}-C_{L}-AR_{L}, B_{L}-C_{L}-A_{FR} and B_{L}-C_{L}-A_{RR} and for the point triplets B_{R}-C_{R}-A_{FL}, B_{R}-C_{R}-A_{RL}, B_{R}-C_{R}-A_{FR} and B_{R}-C_{R}-A_{RR}, the respective direction of rotation is determined when traversing the polylines spanned by these points. If the traversals through all of the polylines do not result in the same direction of rotation, a lateral collision situation with the surrounding object is present.

It is then checked whether a longitudinal collision situation is present. For this purpose, for each corner of the vehicle body contour of the vehicle 1, its position relative to the front and rear contour lines C_{L}-C_{R} and B_{L}-B_{R} of the surrounding object U is determined based on the direction of rotation method described above. This means that, for the point triplets C_{L}-C_{R}-A_{FL}, C_{L}-C_{R}-A_{RL}, C_{L}-C_{R}-A_{FR} and C_{L}-C_{R}-A_{RR} and for the point triplets B_{L}-B_{R}-A_{FL}, B_{L}-B_{R}-A_{RL}, B_{L}-B_{R}-A_{FR} and B_{L}-B_{R}-A_{RR}, the respective direction of rotation is determined when traversing the polylines spanned by these points. If the traversals through all of the polylines do not result in the same direction of rotation, a longitudinal collision situation with the surrounding object is present.

If it is identified by the method steps described above that neither a lateral nor a longitudinal collision situation is present, the vehicle 1 is able to be moved along the trajectory without collision in relation to this checked surrounding object.

If, as shown in FIG. 5, a multiplicity of surrounding objects U are arranged along the trajectory T, the method described above has to be applied iteratively in order to ensure that there will be no collisions with any of the surrounding objects along the trajectory of the vehicle 1.

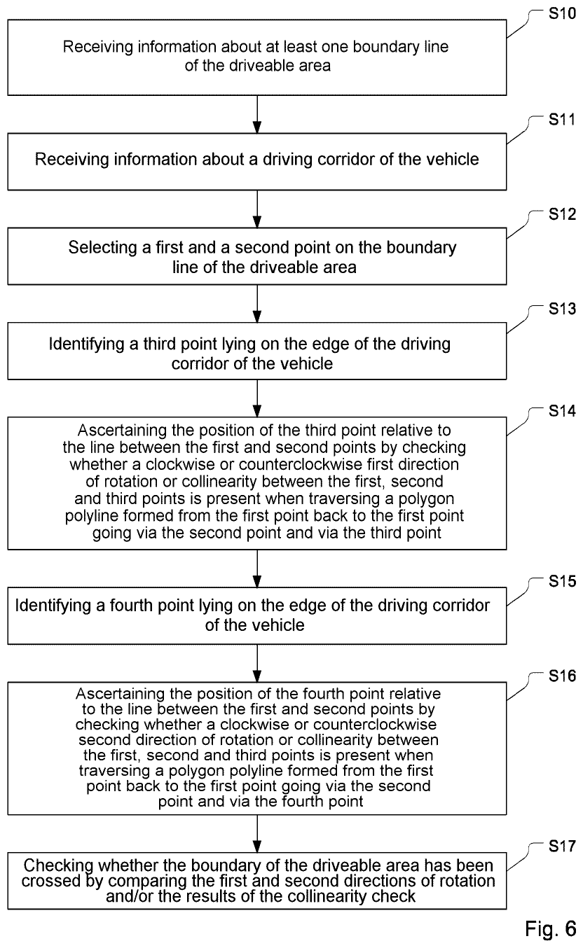

FIG. 6 shows a block diagram illustrating the steps of the method for checking whether a vehicle moving along a trajectory has crossed a boundary of the driveable area.

Information about at least one boundary line of the driveable area is first received (S10). The boundary line may in this case be a boundary line in free space or relate to a surrounding object.

In addition, information about a driving corridor of the vehicle is received, wherein the driving corridor is the area covered by a projection of the vehicle body contour onto the road when driving through the trajectory (S11). This driving corridor must lie in the driveable area or must be collision-free in order to avoid a collision between the vehicle and surrounding objects.

Next, a first and a second point on the boundary line of the driveable area are selected, wherein the first point lies behind the second point in the direction of travel of the vehicle (S12).

A third point, lying on the edge of the driving corridor of the vehicle, is also identified (S13). This third point is in particular a point on the vehicle body contour of the vehicle that defines for example a corner of the vehicle body contour.

The position of the third point relative to the line between the first and second points is then ascertained by checking whether a clockwise or counterclockwise first direction of rotation or collinearity between the first, second and third points is present when traversing a polyline formed from the first point to the third point going via the second point (S14).

In addition, at least one fourth point lying on the edge of the driving corridor of the vehicle and different from the third point is identified (S15). This fourth point is in particular a point on the vehicle body contour of the vehicle that defines for example a further corner of the vehicle body contour.

The position of the fourth point relative to the line between the first and second points is then ascertained by checking whether a clockwise or counterclockwise second direction of rotation or collinearity between the first, second and third points is present when traversing a polygon polyline formed from the first point to the fourth point going via the second point (S16).

Finally, it is checked, by comparing the first and second directions of rotation and/or the results of the collinearity check, whether the boundary of the driveable area has been crossed (S17).

The present disclosure has been described above using example embodiments. It will be understood that numerous changes and modifications are possible without thereby departing from the scope of protection defined by the patent claims.

### LIST OF REFERENCE SIGNS

1 vehicle
2 sensor
3 computing unit
A_{FL} third point
A_{RL} fourth point
B first point
C second point
F vehicle body contour
FR direction of travel
G1 left boundary line
G2 right boundary line
T trajectory
U surrounding object

1. A computer-implemented method for checking whether a vehicle moving along a trajectory has crossed a boundary of a driveable area, wherein the method comprises the following steps:
a) receiving, by computer hardware, information about at least one boundary line of the driveable;
b) receiving, by the computer hardware information about a driving corridor of the vehicle, wherein the driving corridor is an area covered by a projection of a vehicle body contour onto a road when driving through the trajectory;
c) selecting, by the computer hardware, a first point and a second point on the at least one boundary line of the driveable area, wherein the first point lies behind the second point in a direction of travel of the vehicle;
d) identifying, by the computer hardware, a third point lying on an edge of the driving corridor of the vehicle;
e) ascertaining, by the computer hardware, a position of the third point relative to a line between the first and second points by checking whether a clockwise or counterclockwise first direction of rotation or collinearity between the first, second and third points is present when traversing a polyline formed from the first point to the third point going via the second point;
f) identifying, by the computer hardware, at least one fourth point lying on the edge of the driving corridor of the vehicle and different from the third point;
g) ascertaining, by the computer hardware, a position of the at least one fourth point relative to the line between the first and second points by checking whether a clockwise or counterclockwise second direction of rotation or collinearity between the first, second and fourth points is present when traversing a polyline formed from the first point to the fourth point going via the second point;
h) checking, by the computer hardware, whether the boundary of the driveable area has been crossed by comparing at least one of the first and second directions of rotation and/or the results of the collinearity check; and
g) controlling the vehicle based upon whether the boundary of the driveable area has been crossed.

2. The method as claimed in claim 1, wherein the third and fourth points are each a vertex of a polygon replicating the vehicle body contour, and wherein the third and fourth points relate to a common sideline of the vehicle body contour and are each a vertex of the right or left sideline of the vehicle body contour.

3. The method as claimed in claim 1, wherein, checking whether the boundary of the driveable area has been crossed comprises ascertaining whether the first and second directions of rotation are the same or different.

4. The method as claimed in claim 1, wherein the at least one boundary line of the driveable area is approximated by multiple points spaced apart from one another, and pairs of points of the at least one boundary line are selected at successive times as first and second points and are used to ascertain the first and second directions of rotation and to check whether the boundary of the driveable area has been crossed.

5. The method as claimed in claim 1, wherein the driveable area has a left boundary line and a right boundary line that are spaced apart from one another and define a lane, the vehicle body contour is approximated by a rectangle having a pair of left corners and a pair of right corners, and a first direction of rotation and a second direction of rotation are ascertained for the pair of left corners and, based on the first and second directions of rotation, it is checked whether the vehicle has crossed the left boundary line of the driveable area.

6. The method as claimed in claim 1, wherein the driveable area has a left boundary line and a right boundary line that are spaced apart from one another and define a lane, the vehicle body contour is approximated by a rectangle having a pair of left corners and a pair of right corners, and a first direction of rotation and a second direction of rotation are ascertained for the pair of right corners and, based on the first and second directions of rotation, it is checked whether the vehicle has crossed the right boundary line of the driveable area.

7. The method as claimed in claim 1, wherein the driveable area has a left boundary line and a right boundary line that are spaced apart from one another and define a lane, in the vehicle body contour is approximated by a rectangle having two left and two right corners, a position of at least the two left corners relative to the line between the first and second points lying on the left boundary line is checked at least intermittently, a direction of rotation is determined at least for each of the two left corners by determining a direction of rotation for each left corner when traversing a polyline formed from the first point to the respective corner going via the second point, and it is checked whether the two directions of rotation are oriented clockwise.

8. The method as claimed in claim 1, wherein the driveable area has a left boundary line and a right boundary line that are spaced apart from one another and define a lane, the vehicle body contour is approximated by a rectangle having two left and two right corners, a position of the two right corners relative to the line between the first and second points lying on the right boundary line is checked at least intermittently, a direction of rotation is determined for each of the two right corners by determining a direction of rotation for each right corner when traversing a polyline formed from the first point to a respective corner going via the second point, and it is checked whether the two directions of rotation are oriented counterclockwise.

9. The method as claimed in claim 1, wherein the boundary line of the driveable area relates to a boundary line of a localized surrounding object in a surrounding area of the vehicle, wherein the surrounding object is described by a bounding box, and the first and second points define a line of the bounding box that relates to a side of the surrounding object that faces the vehicle.

10. The method as claimed in claim 9, wherein the vehicle body contour is approximated by a rectangle having four corners, the surrounding object is approximated by a rectangular bounding box having four corners, for each line of the rectangular bounding box, in each case a position of all of the corners of the rectangle of the vehicle body contour relative to the respective line is determined by in each case determining the direction of rotation when traversing the polyline between the end points of the respective line of the rectangular bounding box and the respective corner of the rectangle of the vehicle body contour and, after the directions of rotation have been determined, it is checked whether all of the directions of rotation are the same.

11. A driver assistance system that is designed to check whether a vehicle has crossed a boundary of a driveable area, wherein the driver assistance system comprises multiple sensors arranged in a manner distributed around a vehicle, and a computing unit for processing the information provided by the sensors, wherein the computing unit is configured to perform steps:
a) receiving information about at least one boundary line of the driveable area;
b) receiving information about a driving corridor of the vehicle, wherein the driving corridor is the area covered by a projection of a vehicle body contour onto a road when driving through a trajectory;
c) selecting a first point and a second point on the boundary line of the driveable area, wherein the first point lies behind the second point in a direction of travel of the vehicle;
d) identifying a third point lying on an edge of the driving corridor of the vehicle;
e) ascertaining a position of the third point relative to a line between the first and second points by checking whether a clockwise or counterclockwise first direction of rotation or collinearity between the first, second and third points is present when traversing a polyline formed from the first point to the third point going via the second point;
f) identifying at least one fourth point lying on the edge of the driving corridor of the vehicle and different from the third point;
g) ascertaining a position of the fourth point relative to the line between the first and second points by checking whether a clockwise or counterclockwise second direction of rotation or collinearity between the first, second and fourth points is present when traversing a polyline formed from the first point to the fourth point going via the second point; and
h) checking whether the boundary of the driveable area has been crossed by comparing at least one of the first and second directions of rotation or results of the collinearity check.
